(19) United States
(12) Patent Application Publication
(10) Pub. No.: US 2026/0119650 A1
(43) Pub. Date: Apr. 30, 2026

(54) SYSTEMS AND METHODS FOR ONTOLOGY-BASED SECURITY REMEDIATION

(71) Applicant: Wells Fargo Bank, N.A., San Francisco, CA (US)

(72) Inventors: Jerry Joseph Reynolds, Charlotte, NC (US); Michael Sbandi, Charlotte, NC (US); Bradford A. Shea, Mint Hill, NC (US); Michael Erik Meinholz, Charlotte, NC (US)

(21) Appl. No.: 18/930,623

(22) Filed: Oct. 29, 2024

(51) Int. Cl. G06F 21/55

(52) U.S. Cl. CPC G06F 21/554; G06F 2221/034

(57) ABSTRACT

Systems, apparatuses, methods, and computer program products are disclosed for ontology-based security remediation. An example method includes receiving first system data associated with a first system, wherein the first system data includes operational data and context data. The example method also includes determining, based at least on the operational data and a security ontology, that the first system is undergoing a security issue that corresponds to a historical security issue associated with a second system. The example method also includes identifying, based on the security ontology, a solution implementation based on the historical issue. The example method also includes generating a modified solution implementation based at least on the context data. The example method also includes performing an action set for the first system based at least on the modified solution implementation.

### BACKGROUND

Transferring knowledge gained from solving one technical issue to a different, non-identical technical issue can be challenging. For example, cybersecurity attacks can arise in a unique context with their own set of variables, dependencies, and interactions, and what works to solve one specific issue may or may not be directly applicable or effective in a different context where variables and conditions differ.

### BRIEF SUMMARY

Addressing cybersecurity issues among disparate systems can be challenging due to the complex nature of modern information technology (IT) environments in which systems exhibit a wide range of different configurations, interactions, and dependencies. In other words, each system is unique, and even when two systems may face similar issues, the underlying causes and effective solutions may differ significantly. Thus, applying a standardized approach is ineffective, especially when aiming to develop systems that are not just resilient, but anti-fragile.

Anti-fragility implies that a system should not only be able to withstand cyberattacks, but also learn and adapt from those attacks to become more robust over time. Achieving anti-fragility is complicated by differences in system configurations; different systems may operate on varying platforms, use different software versions, and/or exist in distinct network environments. A security patch or similar solution that resolves a vulnerability in one system may not be applicable (and could even be harmful) in another system that is configured differently. Moreover, as different systems have different levels of resilience, and a solution that is effective in a less robust system might be overkill for a different and more resilient system.

Another factor adding to the difficulty of applying solutions learned from one issue to another is that the behavior of cybersecurity attacks can differ across systems due to variations in network traffic patterns, user behavior patterns, and the specific nature of data being stored and/or processed. These challenges underscore the need for a more sophisticated and context-driven approach to cybersecurity remediation that accounts for unique characteristics of diverse and disparate computing systems.

Traditional approaches that rely on static rules or other simplistic techniques to identify and/or resolve security issues often fall short in modern dynamic computing environments. After all, as computing environments become more complex, so do attack vectors used against those computing environments. In contrast to conventional techniques for security remediation, example embodiments described herein leverage a sophisticated machine learning-based framework which includes a security ontology to identify and remedy issues across a plurality of disparate systems effectively. As described further herein, example embodiments set forth an approach that is adaptive to specific nuances of a given system, taking into account its configurations, dependencies, and other contextual factors, in order to not only determine and implement a solution for the issue faced by the system, but to also enhance anti-fragility of the system in parallel.

In various example embodiments, an advanced security ontology may be leveraged to determine an optimal tailored solution for a given cybersecurity issue. In various embodiments, the security ontology may encompass detailed information about historical security issues including the nature of the issues, a context in which they occurred, and proven solutions to those issues. When addressing a new issue, example embodiments may query the security ontology to identify similar historical incidents by matching key characteristics and/or data patterns and in turn identify a solution implementation used in the similar historical incidents. Example embodiments may additionally modify the identified solution implementation based on context data of the affected system to determine a modified solution implementation which provides a tailored solution specific to the system.

In various example embodiments, the modified solution implementation may be further informed by automatically generating and deploying one or more decoy resources to gain additional knowledge in real-time as to the specific nature of a cybersecurity threat. In this manner, resulting attack interaction data gained from an attacking entity's interactions with the decoy resource may be used to determine additional strategies and/or solutions for addressing the cybersecurity threat.

Accordingly, the present disclosure sets forth systems, methods, and apparatuses that provide improved security remediation for diverse computing systems. There are many advantages of these and other embodiments described herein. For instance, by integrating an advanced security ontology along with a suite of machine learning models, example embodiments described herein provide a strong foundation for diagnosing issues and determining solutions based on a comprehensive understanding of historical cybersecurity issues and their corresponding resolutions. This approach enables the systems to adapt to diverse configurations and contexts, overcoming limitations of one-size-fits-all solutions by developing tailored solutions based on specific nuances of each system. The security ontology facilitates a deep semantic understanding of prior issues and solutions, which allows the system to leverage historical experiences effectively enhance responses to threats in real-time. Further, by automatically generating and deploying decoy resources to capture real-time threat behavior, diagnostic capabilities are enhanced, and actionable insights may be provided that refine and improve accuracy of the systems recommendations. This context-aware approach fosters continuous learning and adaptation, and ultimately strengthens the cybersecurity posture of the systems which it protects.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used.

FIG. 2A illustrates a schematic block diagram of example circuitry embodying a system device that may perform various operations in accordance with some example embodiments described herein.

FIG. 2B illustrates a schematic block diagram of an example modeling engine that may perform various operations in accordance with some example embodiments described herein.

FIG. 2C illustrates a schematic block diagram of an example mitigation engine that may perform various operations in accordance with some example embodiments described herein.

FIG. 3 illustrates an example flowchart for ontology-based security remediation, in accordance with some example embodiments described herein.

FIG. 4 illustrates an example flowchart for determining that a system is undergoing a security issue, in accordance with some example embodiments described herein.

FIG. 5 illustrates an example flowchart for determining and deploying decoy resources, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

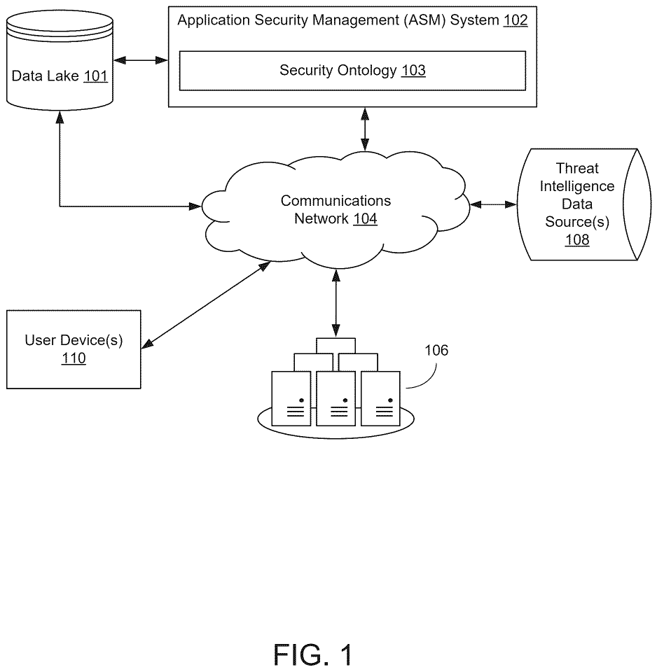

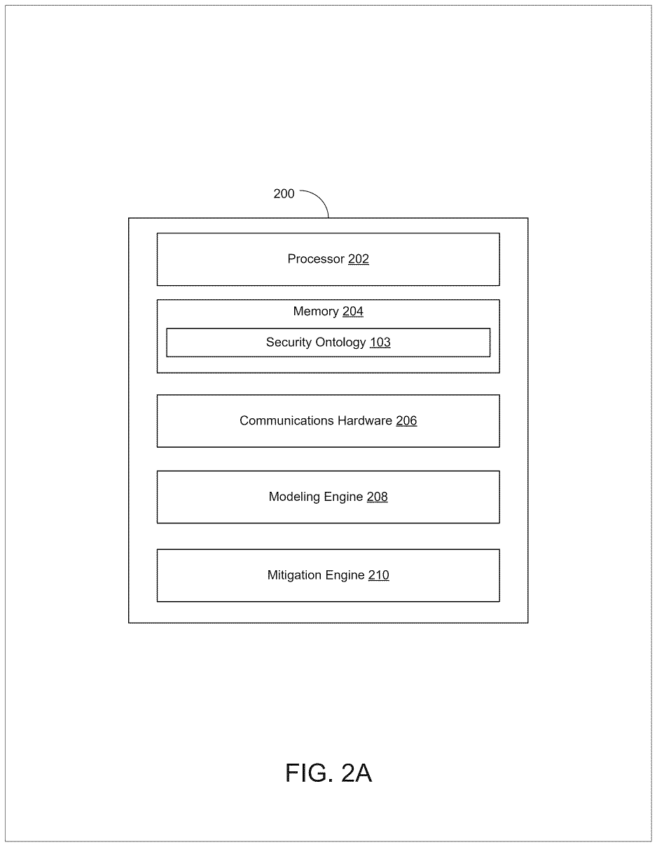

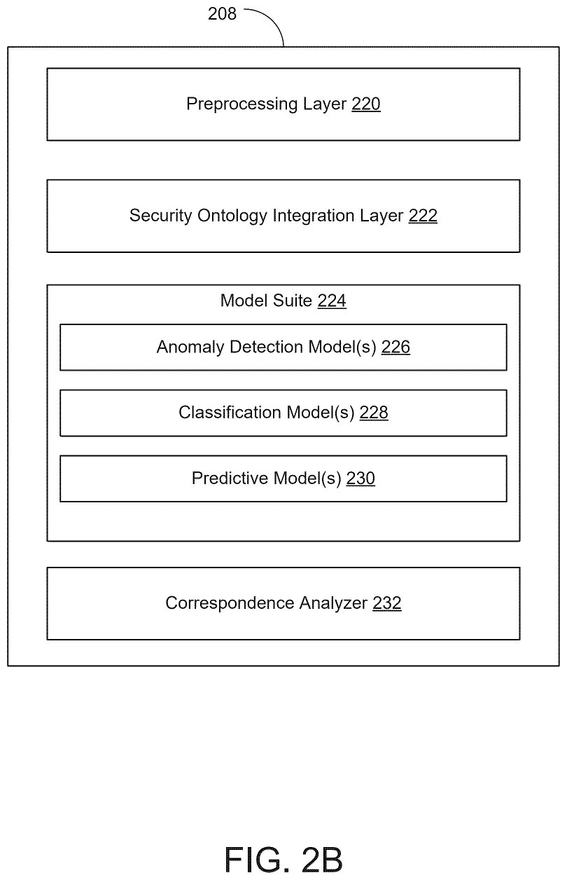

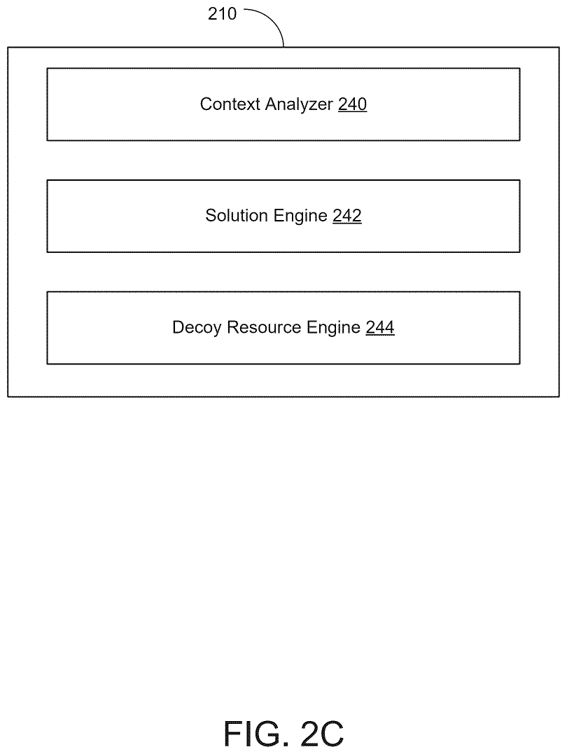

Example embodiments described herein may be implemented using any of a variety of computing devices or servers. To this end, FIG. 1 illustrates an example environment 100 within which various embodiments may operate. As illustrated, an application security management (ASM) system 102 may store a security ontology 103 (described below in connection with FIG. 2A) and may receive and/or transmit information via communications network 104 (e.g., the Internet) with any number of other sources, such as a data lake 101, one or more systems 106, one or more threat intelligence data sources 108, and/or one or more user devices 110.

The ASM system 102 may be implemented as one or more computing devices or servers, which may be composed of a series of components. Particular components of the ASM system 102 are described in greater detail below with reference to apparatus 200 in connection with FIGS. 2A-2C.

In some embodiments, the ASM system 102 further includes a storage device that comprises a distinct component from other components of the ASM system 102. The storage device may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). The storage device may host the software executed to operate the ASM system 102. The storage device may store information relied upon during operation of the ASM system 102, such as various models that may be used by the AAA system 102, data (e.g., system data) to be processed using the ASM system 102, the security ontology 103, and/or the like. In addition, the storage device may store control signals, device characteristics, and access credentials enabling interaction between the ASM system 102 and one or more sources, such as data lake 101, one or more systems 106 and/or one or more threat intelligence data sources 108.

The data lake 101 may comprise a storage system that stores a vast amount of structured and unstructured data associated with a plurality of different systems. This data may include, for example, system logs, attack vectors, operational data, context data, network traffic data, security alerts, incident response records, vulnerability reports, threat intelligence data (e.g., from threat intelligence data sources 108 further described below), and the like. The structured and unstructured data stored in data lake 101 may include diverse data types from various sources, such as antivirus software, firewalls, intrusion detection software, operating systems, networks, and the like. The data lake 101 may include data about historical security issues, and each issue may be tagged with metadata that describes the issue along with data about the affected systems.

In various embodiments, data lake 101 may be leveraged to generate a security ontology 103 and to train one or more machine learning models to recognize patterns and identify historical security issues that may align with a current security issue. For example, security ontology 103 may be generated by ASM system 102 through processing structured and unstructured data stored in the data lake, determining relationship, classification, and hierarchy information between different entities (e.g., affected systems, threat types, and solution implementations taken to solve issues) and organize this information into an ontology that represents knowledge and context of historical security issues. The security ontology 103 may comprise a formal, structured representation of knowledge regarding a wealth of cybersecurity issues. In this regard, the security ontology 103 may serve as a semantic framework that provides meaning to the data stored by data lake 101 in order to enable ASM system 102 to understand and process data more effectively.

The security ontology 103 may be structured in various ways. In some examples, security ontology 103 may comprise concepts (e.g., classes) to represent entities, and each concept may be associated with attributes that describe characteristics of the respective concept. An example class may be an “attack” class, which may include attributes such as “causes,” “attack vector,” and “severity level.” Security ontology 103 may also include instances of concepts (e.g., real-world entities mapped to certain concepts). For instance, a “vulnerability” concept may map to an instance regarding a known vulnerability that organizations may encounter. Security ontology 103 may also include axioms that define constrains or conditions within the ontology and govern how concepts and relationships interact to ensure consistency.

In various embodiments, security ontology 103 may be utilized by ASM system 102 to index data stored in data lake 101 such that the data is organized and made more searchable. In this manner, the security ontology 103 may be queried by components of ASM system 102 (e.g., modeling engine 208 and/or mitigation engine 210 as described further herein) to inform determinations made by ASM system 102 (e.g., regarding optimal solution implementations or the like).

Although shown in FIG. 1 as being incorporated within ASM system 102, the security ontology 103 may in some embodiments be hosted externally from ASM system 102, such as within another system or external storage apparatus.

The one or more systems 106 may include any computing devices known in the art. The one or more systems 106 may also include both hardware-based systems and software-based systems (e.g., software tools, applications, and the like). In various embodiments, systems 106 may include for example, cloud computing environment services, such as virtual machines, databases and other storage mechanisms, and/or containerized applications. In various embodiments, systems 106 may also include enterprise IT systems and associated infrastructure components, such as, for example, servers, workstations, routers, switches, firewalls, databases, Internet-of-Things (IOT) devices and sensors, point-of-sale (POS) devices, web servers, and the like. In various embodiments, systems 106 may include various software-based applications and tools. For example, systems 106 may comprise software applications, mobile applications, development tools, version control software, communication platforms (e.g., email applications, messaging applications, video conferencing applications), project management software, customer relationship management (CRM) software, Application Programming Interfaces (APIs), data analytics tools, dashboard visualization tools, and the like.

The one or more systems 106 need not themselves be independent devices, but may be peripheral devices communicatively coupled to other computing devices. In various embodiments, as discussed herein, ASM system 102 may receive system data (including operational data and context data) from one or more systems of the systems 106.

The one or more threat intelligence data sources 108 may be embodied by any computing devices known in the art. The one or more threat intelligence data sources 108 need not themselves be independent devices, but may be peripheral devices communicatively coupled to other computing devices. In various embodiments, threat intelligence data sources 108 may collect and distribute data regarding various cybersecurity threats, known attacks, and vulnerabilities. threat intelligence data sources 108 may comprise a variety of sources including, for example, government agencies, public databases, open source groups, threat intelligence provider services, and the like.

In various embodiments, threat intelligence data may be received by the ASM system 102 from one or more threat intelligence data sources 108. In various embodiments, threat intelligence data may comprise data regarding known attack vectors (e.g., specific methods used to infiltrate systems such as phishing methods, zero-day exploits, malware distribution, etc.), indicators of compromise (IOCs), detected vulnerabilities in software or hardware, attack patterns, and the like. In various embodiments, ASM system 102 may utilize threat intelligence data from threat intelligence data sources 108 to inform a determination as to whether a system is undergoing a security issue, as well as to inform a determination of an optimal solution implementation for a given system.

The one or more user devices 110 may be embodied by any computing devices known in the art. The one or more user devices 110 need not themselves be independent devices, but may be peripheral devices communicatively coupled to other computing devices. In various embodiments, users may interact with the ASM system 102 through a user device 110 to access various data, such as output of one or more models, user interface (UI) visualizations of detected patterns, potential security issue alerts, and/or remediation recommendations. Additionally, in various embodiments, a UI may also allow users to engage the security ontology 103 such that a structured visual view of how security threats and system components may be interconnected. In various embodiments, ASM system 102 may push real-time alerts (e.g., as part of a solution implementation) regarding an affected system to one or more user devices 110.

Although FIG. 1 illustrates an environment and implementation in which the ASM system 102 interacts indirectly with a user via one or more of user devices 110, in some embodiments users may directly interact with the ASM system 102 (e.g., via communications hardware of the ASM system 102), in which case a separate user device 110 may not be utilized. Whether by way of direct interaction or indirect interaction via another device, a user may communicate with, operate, control, modify, or otherwise interact with the ASM system 102 to perform the various functions and achieve the various benefits described herein.

### Example Implementing Apparatuses

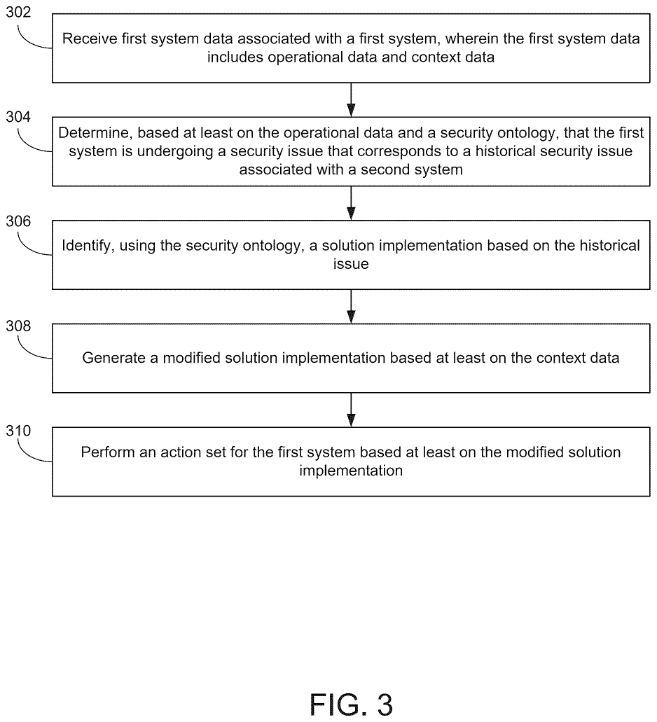

The ASM system 102 (described previously with reference to FIG. 1) may be embodied by one or more computing devices or servers, shown as apparatus 200 in FIG. 2A. The apparatus 200 may be configured to execute various operations described above in connection with FIG. 1 and below in connection with FIGS. 3-5. As illustrated in FIG. 2A, the apparatus 200 may include processor 202, memory 204 (which may store security ontology 103), communications hardware 206, modeling engine 208, and mitigation engine 210, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein. In various embodiments memory 204 may store security ontology 103.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises a modeling engine 208 that determine, based at least on operational data and a security ontology (e.g., security ontology 103), that a given system is undergoing a security issue that corresponds to a historical security issue associated with a second system. The modeling engine 208 may utilize processor 202, memory 204, or any other hardware component included in the apparatus 200 to perform these operations, as described in connection with FIGS. 3-5 below. The modeling engine 208 may further utilize communications hardware 206 to gather data from a variety of sources (e.g., data lake 101, security ontology 103, threat intelligence data sources 108, and/or user devices 110, as shown in FIG. 1), and/or exchange data with a user, and in some embodiments may utilize processor 202 and/or memory 204, and/or mitigation engine 210 to determine that a given system is undergoing a security issue.

Turning briefly to FIG. 2B, an example modeling engine 208 is shown with various example interconnected components. In various embodiments, modeling engine 208 may include a preprocessing layer 220, a security ontology integration layer 222, a model suite 224 that includes one or more anomaly detection models 226, one or more classification models 228, and one or more predictive models 230, and a correspondence analyzer 232.

As shown in FIG. 2B, preprocessing layer 220 may collect operational data associated with a first system (e.g., received via communications hardware 206) and preprocess the operational data to transform (e.g., clean, normalize, and/or structure) the operational data into a suitable form to be processed by the security ontology integration layer 222 and the model suite 224. In some embodiments, preprocessing layer 220 may transform the operational data by performing feature extraction to convert the operational data into meaningful features that represent a current state of the first system. In some embodiments, features may be selected based on certain cybersecurity metrics, such as indicators of system performance, security status, and the like. In various embodiments, preprocessing layer may employ Principal Component Analysis (PCA) and/or one or more feature selection methods for automatically identifying relevant features from the operational data.

Additionally, in various embodiments, preprocessing layer 220 may engineer certain features based on statistical metrics (e.g., standard deviation, mean or average, skewness, variance, percentiles, z-score, median, etc.). For example, for operational data related to network traffic, a feature may be engineered to represent an average size of data packets received by the first system over a certain time period (an increase in average packet size may suggest certain forms of attacks such as Distributed Denial of Service (DDoS) attacks). As another example, for operational data related to user behavior, a high standard deviation in time between login attempts by a user may indicate a brute-force (trial and error) attack to gain access to the first system.

In various embodiments, the preprocessing layer 220 may generate a plurality of feature vectors (e.g., numerical arrays representing the operational data) based on selected and engineered features. In some embodiments, preprocessing layer 220 may pass feature vectors to the security ontology integration layer 222 for further processing. For example, prior to passing feature vectors to the model suite 224, feature vectors may be processed using the security ontology integration layer 222 to further contextualize the feature vectors. The ontology integration layer 222 may interact with (e.g., query) the security ontology 103 to map features to concepts and/or categories defined by the security ontology 103 in order to provide additional semantic meaning to feature vectors. For example, a feature relating to average size of data packets received by the first system may be mapped to an ontology class relating to network traffic, which may include data regarding deviations or thresholds in data packet size that is indicative of certain attacks. This data may then be included as part of the feature vector (e.g., for further processing by model suite 224). In this manner, a fuller context is provided for the models of model suite 224 to determine anomalies and classify issues experienced by the first system.

As shown in FIG. 2B, the model suite 224 may include one or more anomaly detection models 226, one or more classification models 228, and one or more predictive models 230. In various embodiments, models of the model suite 224 may be trained on historical data, such as data stored by data lake 101, to recognize patterns, correlations, and/or anomalies relating to cybersecurity issues.

In various embodiments, one or more anomaly detection models 226 may process feature vectors to identify deviations from normal behavior. In various embodiments, anomaly detection models 226 may use various techniques to detect unusual patterns in the features, such as in user behaviors, network traffic, and/or more general system activity. Some examples of anomaly detection models 226 that may be included in model suite 224 include Support Vector Machine (SVM) models, Gaussian Mixture Models (GMM), isolation forest models, autoencoders, and/or the like. Regardless of the specific types of anomaly detection models, anomaly detection models 226 may process feature vectors to evaluate whether they deviate from learned normal patterns. In various example embodiments, anomaly detection models 226 may determine an anomaly score indicating how likely a data point is to be anomalous.

In various embodiments, one or more classification models 228 may process feature vectors to predict categorical labels for data points, in order to assign a feature vector to one or more predefined classes. Some examples of classification models 228 that may be included in model suite 224 include SVM models, logistic regression models, tree models such as random forest and/or decision trees, neural networks (e.g., convolutional neural networks (CNNs)), probabilistic models, and/or the like. Regardless of the specific types of classification models, classification models 228 may output a predicted class label for a feature vector. In some cases, this may comprise a binary value (e.g., representing malicious or normal behavior), whereas other cases may involve multiclass classification.

In various embodiments, one or more predictive models 230 may process feature vectors to forecast potential cybersecurity issues. Some examples of predictive models 230 that may be included in model suite 224 include regression models, time series models, gradient boosting machines (GBMs), neural networks, and/or the like. In some embodiments, predictive models 230 may output predictions in the form of risk scores, which may be used to prioritize deployment of solution implementations and/or the like as further discussed herein.

In various embodiments, correspondence analyzer 232 may leverage both the security ontology 103 and outputs of models in model suite 224 to identify historical security issues that correspond to (e.g., match or exhibit similarity to) current issues identified from operational data. In various embodiments, correspondence analyzer may map feature vectors and model outputs to historical security issues by aligning them with known attack types, patterns, and/or vulnerabilities represented by the security ontology 103. In some embodiments, correspondence analyzer 232 may leverage outputs from one or more models of model suite 224 to calculate similarity scores between feature vectors processed by the models and feature vectors associated with historical security issues (e.g., feature vectors found in security ontology 103). In some embodiments, similarity scores may be calculated based on, for example, cosine similarity, Euclidean distance, or the like between feature vectors. In this regard, by combining ontology-based context with model outputs, the correspondence analyzer 232 may recognize patterns and identify historical security issues that are similar to a presently exhibited issue.

In addition, the apparatus 200 further comprises a mitigation engine 210 that identifies, using the security ontology, a solution implementation based on the historical issue and generates a modified solution implementation based at least on context data. The mitigation engine 210 may utilize processor 202, memory 204, or any other hardware component included in the apparatus 200 to perform these operations, as described in connection with FIGS. 3-5 below. The mitigation engine 210 may further utilize communications hardware 206 to gather data from a variety of sources (e.g., data lake 101, security ontology 103, threat intelligence data sources 108, and/or user devices 110, as shown in FIG. 1) and/or exchange data with a user, and in some embodiments may utilize processor 202 memory 204, and/or modeling engine 208 to identify solution implementations and generate modified solution implementations.

In various embodiments, mitigation engine 210 may build upon the outputs of modeling engine 208 to select an appropriate response to a security issue affecting a system (e.g., identify a solution implementation) and adapt the response to the affected system based on context data for the system, ensuring that the solution is effective given the system's existing defenses and other attributes. Additionally, in some embodiments and as described below, mitigation engine 210 may automatically deploy various resources to aid its determination of an optimal solution implementation.

As shown in FIG. 2C, an example mitigation engine 210 includes a context analyzer 240, solution engine 242, and decoy resource engine 244.

In various embodiments, context analyzer 240 may analyze system data associated with an affected system, including context data associated with the affected system. In various embodiments, context data may include configuration data and defense data of the affected system. Configuration data may include data that defines operational characteristics of a system, including, for example, hardware specifications (component serial numbers, etc.), network configuration, operating system information, versions of installed software, customized settings, and the like. Configuration data may also include dependencies between different components, active protocols, update history, and the like. Defense data may include data that describes an array of mechanisms that the system employs to protect against cyberattacks. Defense data may include data regarding active firewalls, intrusion detection systems, antivirus software, encryption methods, multi-factor authentication (MFA) protocols, access control tools, historical data regarding security patches, security policies, and the like. Through analysis of the system data, context analyzer 240 may determine differences between the currently affected system and a system associated with the historical security issue to ensure that a solution implementation tailored and scaled appropriately.

In various embodiments, solution engine 242 may determine how a solution implementation applied to resolve the historical security issue should be modified for a currently affected system. For instance, if the currently affected system has more robust defenses in place, solution engine 242 may recommend a scaled back response. If the system is more vulnerable, however, the solution engine 242 may modify the solution implementation to include additional measures to be undertaken. In some embodiments, solution engine 242 may utilize one or a combination of machine learning models, decision trees, and/or rules-based logic to assess effectiveness of solution implementations and modify them accordingly.

In some embodiments, decoy resource engine 244 may determine a resource corresponding to identified attack pattern data and cause deployment of a decoy resource within an affected system. In this manner, decoy resources such as ephemeral environments or honeypots may be determined, generated, and deployed in real-time during an active cyberattack on the affected system to gain more knowledge about the cyberattack and in turn use that knowledge to inform the determination on the most optimal solution implementation. A decoy resource may comprise an asset designed to mimic legitimate system data or infrastructure and present an attractive target for an attacker (drawing them away from actual valuable resources within the system). In various embodiments, as described herein, when attackers interact with decoy resources, attack interaction data may be generated based on the interactions, which may inform mitigation engine 210 as to specific methods, attack vectors, or the like being presently used by the attacker. Example decoy resources may include honeypots, which are simulated systems that mimic the behavior of real systems, such as databases, servers, networks, or the like, and are configured to capture information about attacker methods by recording all interactions and activities of the attacker.

Although components 202-210 are described in part using functional language, it will be understood that the particular implementations necessarily include the use of particular hardware. It should also be understood that certain of these components 202-210 may include similar or common hardware. For example, the modeling engine 208 and mitigation engine 210 may each at times leverage use of the processor 202, memory 204, security ontology 103 or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the modeling engine 208 and mitigation engine 210 may leverage processor 202, memory 204, or communications hardware 206 as described above, it will be understood that any of modeling engine 208 and mitigation engine 210 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that modeling engine 208 and mitigation engine 210 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2A, that loading the software instructions onto a computing device or apparatus produces a special-purpose machine comprising the means for implementing various functions described herein.

Having described specific components of example apparatus 200, example embodiments are described below in connection with a series of flowcharts.

### Example Operations

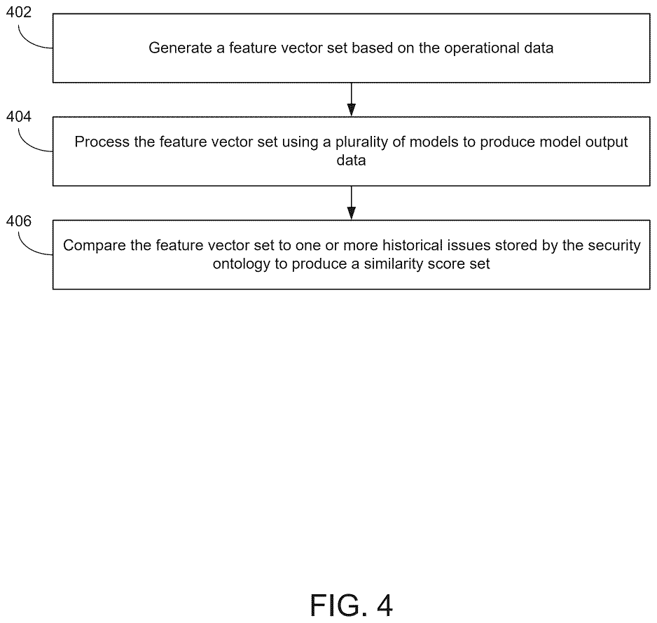

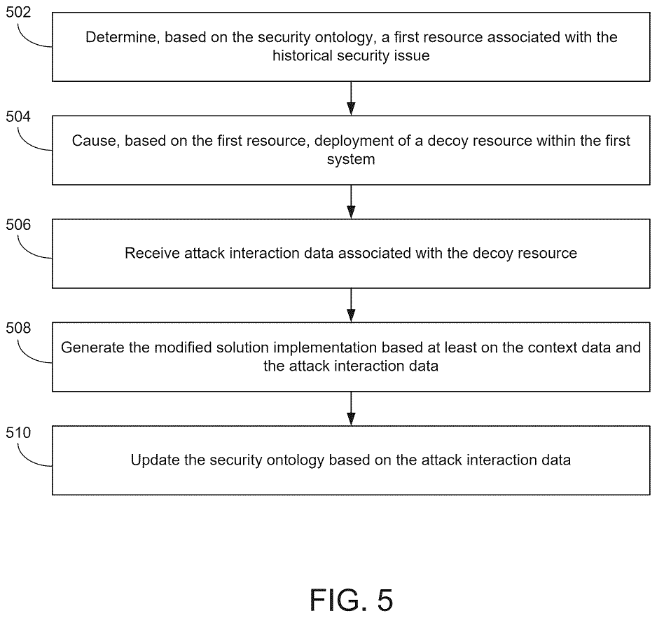

Turning to FIGS. 3-5, example flowcharts are illustrated that contain example operations implemented by example embodiments described herein. The operations illustrated in FIGS. 4 and 5 may, for example, be performed by system device of the ASM system 102 shown in FIG. 1, which may in turn be embodied by an apparatus 200, which is shown and described in connection with FIGS. 2A-2C. To perform the operations described below, the apparatus 200 may utilize one or more of processor 202, memory 204, communications hardware 206, modeling engine 208, mitigation engine 210, and/or any combination thereof. It will be understood that user interaction with the ASM system 102 may occur directly via communications hardware 206, or may instead be facilitated by a separate user device 110, as shown in FIG. 1, and which may have similar or equivalent physical componentry facilitating such user interaction.

Turning first to FIG. 3, example operations are shown for ontology-based security remediation. As shown by operation 302, the apparatus 200 includes means, such as processor 202, memory 204, communications hardware 206, or the like, for receiving first system data associated with a first system, wherein the first system data includes operational data and context data.

In various embodiments, operational data comprises real-time and historical data generated (e.g., over a period of time) by various processes and interactions within the first system. Operational data may be tagged with metadata, including timestamps, source tags, network information (e.g., Internet Protocol (IP) addresses, Media Access Control (MAC) addresses, etc.), user information (e.g., user identifiers), location data (e.g., geographic coordinates), and the like. Operational data may include a wealth of data regarding the first system. Examples of operational data may include event log data (e.g., captured events such as application launches, file access, shutdowns, reboots, startups, logins, errors, authentication attempts, etc.), network traffic data (e.g., packet captures, etc.), performance data (e.g., central processing unit (CPU) and/or memory utilization, throughput, latency, etc.), user behavior data (e.g., executed commands, active sessions, etc.), and the like.

In various embodiments, context data may define the first system's operational state by including data detailing the first system's environment, defenses, and configurations. Context data may comprise both configuration data and defense data. Configuration data may comprise data describing settings, versions, and currently configured parameters of software and hardware included in or otherwise used by the first system. Examples of configuration data may include software version data (e.g., versions of applications, operating system(s), libraries), patch and/or update history data, hardware specifications (e.g., component types, memory sizes, storage capacities, network connections, serial numbers, etc.), network settings, background processes, and the like. Defense data may comprise data describing active and passive mechanisms in place that are configured to protect the first system from cyberattacks. Examples of defense data may include data detailing installed antivirus and/or antimalware tools, firewall configuration data, encryption protocols, access control protocols (e.g., single sign-on (SSO), MFA, etc.), current security patch data, security policies, and the like.

In various embodiments, the first system data may be received from one or more components associated with the first system, such as one or more devices, endpoint detection and response (EDR) tools, and/or the like. In some embodiments, system data may be regularly received by the ASM system 102 in real-time and continuously. In some embodiments, system data may be received in batches at periodic intervals (e.g., every hour, every day, etc.). In some embodiments, system data may only be received in response to a particular event having occurred (e.g., from an EDR tool).

In various embodiments, context data may be received in parallel with operational data. In some embodiments, context data may be received after receiving operational data (e.g., as a request from ASM system 102 for the context data). In various embodiments, context data may be received from a variety of sources associated with the first system, such as security mechanisms deployed in the first system, databases (e.g., Configuration Management Databases (CMDB)), an asset management system, and/or the like.

In various embodiments, the first system data may be received from data lake 101 via a retrieval of the system data by the ASM system 102. For instance, data lake 101 may be an endpoint designed to store system data for a plurality of systems. In this regard, the data lake 101 may act as a centralized repository to not only provide data for training (e.g., for model suite 224) and building upon security ontology 103, but also for retrieval by ASM system 102 to monitor and determine instances involving potential security issues.

As shown by operation 304, the apparatus 200 includes means, such as processor 202, memory 204, modeling engine 208, or the like, for determining, based at least on the operational data and a security ontology, that the first system is undergoing a security issue that corresponds to a historical security issue associated with a second system. To do so, ASM system 102 may carry out operations shown in FIG. 4.

As shown by operation 402, the apparatus 200 includes means, such as processor 202, memory 204, communications hardware 206, modeling engine 208, or the like, for generating a feature vector set based on the operational data. As described above, modeling engine 208 may preprocess system data using preprocessing layer 220 to extract features from the system data and generate a plurality of feature vectors. In some embodiments, preprocessing layer 220 may utilize the security ontology 103 to add contextual information to the feature vectors. In this regard, the ontology integration layer 222 may query the security ontology 103 to map features to concepts and/or categories defined by the security ontology 103 in order to provide additional semantic meaning to feature vectors. For example, preprocessing layer 220 may identify key attributes and relationships defined by security ontology 103 (e.g., known dependencies between software components, known vulnerabilities and/or attack vectors, common configuration setups, etc.) and tag features with this information.

As shown by operation 404, the apparatus 200 includes means, such as processor 202, memory 204, communications hardware 206, modeling engine 208, or the like, for processing the feature vector set using a plurality of models to produce model output data. As described above, ASM system 102 may pass the feature vectors one or more trained models of model suite 224, including one or more anomaly detection models 226, one or more classification models 228, and/or one or more predictive models 230, in order to obtain model output data to inform the determination as to whether the first system is undergoing a security issue.

In various embodiments, modeling engine 208 may process the feature vector set using one or more anomaly detection models 226 to evaluate whether the features deviate from learned normal patterns or behavior. In various embodiments, through processing the feature vector set using the one or more anomaly detection models 226, modeling engine 208 may obtain model output data in the form of one or more anomaly detection scores (which may indicate how likely a respective data point is to be anomalous).

In various embodiments, modeling engine 208 may process the feature vector set using one or more classification models 228 to predict class labels for feature vectors. In various embodiments, through processing the feature vector set using the one or more classification models 228, modeling engine 208 may obtain model output data in the form of one or more feature vector classifications. As described above, in some cases, this may comprise a binary value (e.g., representing malicious or normal behavior), whereas other cases may involve multiclass classification. For example, a multiclass classification may comprise labeling a feature vector as a specific type of attack or issue (e.g., phishing, malware, DDoS, normal operations, configuration issue, etc.).

In various embodiments, modeling engine 208 may process the feature vector set using one or more predictive models 230 to forecast potential cybersecurity issues. In various embodiments, through processing the feature vector set using the one or more predictive models 230, modeling engine 208 may obtain model output data in the form of one or more risk scores, which may represent a quantifiable measure of likelihood and/or severity of a security issue.

As shown by operation 406, the apparatus 200 includes means, such as processor 202, memory 204, communications hardware 206, modeling engine 208, or the like, for comparing the feature vector set to one or more historical issues stored by the security ontology to produce a similarity score set. In various embodiments, the determination as to whether the first system is undergoing a security issue that corresponds to a historical security issue associated with a second system is enhanced through a comparison process with the security ontology 103. In this regard, correspondence analyzer 232 of modeling engine 208 may query the security ontology 103 using the feature vectors. The security ontology 103 may comprise a structured set of historical security issues, each represented by its own set of feature vectors, and the correspondence analyzer 232 may compare the current feature vectors against these historical feature vectors using, e.g., Euclidean distance, cosine similarity, or the like. Each comparison may be assigned a similarity score that indicates how close a match a current feature vector is to a historical feature vector. From these comparisons, correspondence analyzer 232 may generate a similarity score set that includes a plurality of similarity scores.

In various embodiments, the ASM system 102 may leverage both the model output data and the similarity score set to determine whether the first system is undergoing a security issue that corresponds to a historical security issue associated with a second system. In some embodiments, as described above, the model output data may comprise a combination of one or more anomaly scores (e.g., produced by one or more anomaly detection models 226), one or more feature vector classifications (e.g., produced by one or more classification models 228), and one or more risk scores (e.g., produced by one or more predictive models 230). In some embodiments, an anomaly score may be compared to a predefined anomaly threshold, and an anomaly score that satisfies (e.g., meets or exceeds) the predefined anomaly threshold may indicate that the first system is exhibiting patterns indicative of a security issue. Likewise, a risk score may be compared to a predefined risk threshold, and a risk score satisfying the predefined risk threshold may indicate that the first system is exhibiting patterns indicative of a security issue and requires attention. In some embodiments, a feature vector classification that corresponds to a security issue (e.g., a known virus) may also indicate that the first system is exhibiting patterns indicative of a security issue. Additionally, a high similarity score in the similarity score set may also indicate that a security issue is present in the first system.

The modeling engine may use model output data and similarity score set produce a holistic determination as to whether the first system is undergoing a security issue that corresponds to a historical security issue. In some embodiments, modeling engine 208 may assign different weights to the outputs (e.g., similarity scores, risk scores, anomaly scores, and/or feature vector classifications) based on relevance to the current context of the first system. For example, in some cases, anomaly scores may be heavily weighted in cases where the first system has historically produced stable system data (i.e., the first system does not have a history of extreme deviations or issues). Similarly, certain feature vector classifications may be weighted heavier based on perceived impact (e.g., “malware” may be weighted heavier than “configuration issue”). Additionally, high similarity scores linked to significant historical security issues may be weighted heavier. The modeling engine 210 may integrate these weighted outputs to determine whether the first system is undergoing a security issue. As one example, in the case of a feature vector classification indicating a known security issue, a risk score satisfying the predefined risk threshold, and a similarity score reflecting a high similarity to a historical security issue of security ontology 103, the modeling engine 208 may determine that the first system is undergoing a security issue.

This multifaceted approach which incorporates both model output data and similarity score set to determine whether a system is undergoing a security issue provides a more accurate assessment by integrating a multitude of insights from various analytical processes. By considering similarity scores, risk scores, anomaly scores, and feature vector classifications, false positives and negatives may be reduced and overall a more reliable and actionable determination is produced.

As shown by operation 306, the apparatus 200 includes means, such as processor 202, memory 204, communications hardware 206, mitigation engine 210, or the like, for identifying, using the security ontology, a solution implementation based on the historical issue. For example, in response to determining that the first system is undergoing a security issue that corresponds to a historical security issue associated with a second system (e.g., a historical issue identified in security ontology 103), the mitigation engine 210 may identify a corresponding solution implementation to the historical issue indicated by the security ontology 103. The solution implementation may comprise a recorded set of data indicating steps that were taken, resources that were deployed, executed code, patches, mitigation techniques, and/or other actions that were performed to resolve the historical issue in the second system.

As shown by operation 308, the apparatus 200 includes means, such as processor 202, memory 204, communications hardware 206, mitigation engine 210, or the like, for generating a modified solution implementation based at least on the context data. In various embodiments, the ASM system 102 may modify an identified solution implementation to more effectively address the current security issue faced by the first system based on the context data associated with the first system.

In various embodiments, context analyzer 240 of mitigation engine 210 may compare the configuration data and the defense data of the first system with historical configuration data and historical defense data associated with the second system (e.g., as indicated by security ontology 103) to identify differences between the first system and second system. Based on these differences, mitigation engine 210 may generate a modified solution implementation to fit the context of the first system. For instance, if the first system has more advanced security mechanisms in place, the modified solution implementation may involve deploying more aggressive countermeasures using additional security techniques that were not available to the second system. In some embodiments, the modified solution implementation may be generated based on the robustness of the first system. In this regard, a less robust first system may involve more scaled back actions and/or limiting the scope of remediation to avoid overloading the first system. Conversely, a modified solution implementation for a more resilient first system may involve more aggressive remediation techniques.

In some example embodiments, ASM system 102 may obtain additional data to better inform the determination of the modified solution implementation. In this regard, ASM system 102 may deploy one or more decoy resources to the first system in an attempt to obtain attack interaction data to learn more about a presently ongoing cyberattack. Turning to FIG. 5, example operations are shown for determining and deploying decoy resources.

As shown by operation 502, the apparatus 200 includes means, such as processor 202, memory 204, mitigation engine 210, or the like, for determining, based on the security ontology, a first resource associated with the historical security issue. In various embodiments, in response to determining that the first system is undergoing a security issue that corresponds to a historical security issue associated with the second system, mitigation engine 210 may determine one or more resources that are associated with the historical security issue. These resources may be, for example, targets of the attack, such as databases, email servers, web servers, firewalls, routers, file servers, virtual machines, user account data, API keys, IoT devices, and/or the like.

As shown by operation 504, the apparatus 200 includes means, such as processor 202, memory 204, mitigation engine 210, or the like, for causing, based on the first resource, deployment of a decoy resource within the first system. For example, in some embodiments, mitigation engine 210 may be configured to automatically generate and deploy a decoy resource, such as a honeypot or the like, that mimics a perceived target resource of the attack. The decoy resource may be designed to lure an attacker by appearing as a legitimate target. For instance, the honeypot may contain fake user data, or may appear to be less protected than other actual valuable resources within the first system. The decoy resource may be configured to reflect current attributes of the first system (e.g., configured in the same manner as other components of the first system). In this regard, the decoy resource may be assigned an IP address, be made discoverable through various protocols, and/or the like.

As shown by operation 506, the apparatus 200 includes means, such as processor 202, memory 204, communications hardware 206, or the like, for receiving attack interaction data associated with the decoy resource. As an attacker interacts with the decoy resource, ASM system 102 may monitor and record interactions (e.g., command executions, types of tools utilized, progression of the attacker, etc.) in the form of attack interaction data. To do so, the decoy resource itself may be configured to log and report attack interaction data back to ASM system 102 continuously. Additionally or alternatively, the ASM system 102 may continue to receive operational data associated with the first system that now includes attack interaction data of the newly deployed decoy resource, as well as how the attacker may be interacting with other components of the first system in order to gain access to the decoy resource.

As shown by operation 508, the apparatus 200 includes means, such as processor 202, memory 204, mitigation engine 210, or the like, for generating the modified solution implementation based at least on the context data and the attack interaction data. In this regard, the modified solution implementation determined by mitigation engine 210 may be revised based on insights gained from the attack interaction data. For example, the attack interaction data may reveal a specific exploit that was not previously accounted for, and thus the solution implementation may be modified to combat that exploit. Additionally or alternatively, the solution implementation may be modified to isolate particular components and/or deploy additional decoy resources in the event that the attack interaction data reveals that the attacker is honing in on certain weaknesses of the first system.

As shown by operation 510, the apparatus 200 includes means, such as processor 202, memory 204, modeling engine 208, or the like, for updating the security ontology based on the attack interaction data. In various embodiments, the attack interaction data gained through deployment of the decoy resource may be integrated back into the ASM system 102 and recorded and semantically linked to security ontology 103 as well as used as training data for one or more models of model suite 224. In doing so, the knowledge base of ASM system 102 may remain up-to-date on recent cyberattack methods.

Returning to FIG. 3, as shown by operation 310, the apparatus 200 includes means, such as processor 202, memory 204, communications hardware 206, mitigation engine 210, or the like, for performing an action set for the first system based at least on the modified solution implementation. In various embodiments, an action set may comprise one or more automated responses aimed at resolving the determined security issue affecting the first system. In some embodiments, performing the action set for the first system based at least on the modified solution implementation comprises automatically causing deployment of a resource set to the first system. A resource set may include, for example, one or more security and/or software patches, instructions to adjust rules associated with the first system (e.g., firewall rules, blocked IP addresses, etc.), and/or the like.

In some embodiments, the resource set may comprise instructions to quarantine one or more components of the first system. Components may be quarantined in order to isolate certain services or the like and prevent the spread of a present cyber attack (while also ensuring that functionality of the first system is maintained). Additionally, in some embodiments, the resource set may comprise one or more decoy resources. For example, additional decoy resources may be deployed in order to generate additional attack interaction data and continue to learn about the cyberattack to further enhance robustness of the ASM system 102.

FIGS. 3, 4, and 5 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
receiving, by communications hardware, first system data associated with a first system, wherein the first system data includes operational data and context data;
determining, by a modeling engine and based at least on the operational data and a security ontology, that the first system is undergoing a security issue that corresponds to a historical security issue associated with a second system;
identifying, by a mitigation engine and using the security ontology, a solution implementation based on the historical security issue;
generating, by the mitigation engine, a modified solution implementation based at least on the context data; and
performing, by the mitigation engine, an action set for the first system based at least on the modified solution implementation.

2. The method of claim 1, further comprising:
determining, by the mitigation engine and based on the security ontology, a first resource associated with the historical security issue;
causing, by the mitigation engine and based on the first resource, deployment of a decoy resource within the first system.

3. The method of claim 2, further comprising:
receiving, by the communications hardware, attack interaction data associated with the decoy resource,
wherein generating the modified solution implementation is further based on the attack interaction data.

4. The method of claim 3, further comprising:
updating, by the modeling engine, the security ontology based on the attack interaction data.

5. The method of claim 1, wherein the operational data comprises one or more of log data, network traffic data, performance data, and user behavior data.

6. The method of claim 1, wherein the context data comprises configuration data and defense data of the first system.

7. The method of claim 1, wherein determining that the first system is undergoing the security issue that corresponds to the historical security issue associated with the second system comprises:
generating, by the modeling engine, a feature vector set based on the operational data;
processing, by the modeling engine, the feature vector set using a plurality of models to produce model output data;
comparing, by the modeling engine, the feature vector set to one or more historical issues stored by the security ontology to produce a similarity score set,
wherein determining that the first system is undergoing the security issue is based at least on the model output data and the similarity score set.

8. The method of claim 1, wherein performing the action set for the first system based at least on the modified solution implementation comprises:
automatically causing, by the communications hardware, deployment of a resource set to the first system.

9. The method of claim 8, wherein the resource set comprises instructions to quarantine one or more components of the first system.

10. The method of claim 8, wherein the resource set comprises one or more decoy resources.

11. An apparatus comprising:
communications hardware configured to receive first system data associated with a first system, wherein the first system data includes operational data and context data;
a modeling engine configured to determine, based at least on the operational data and a security ontology, that the first system is undergoing a security issue that corresponds to a historical security issue associated with a second system; and
a mitigation engine configured to:
identify, using the security ontology, a solution implementation based on the historical security issue;
generate a modified solution implementation based at least on the context data; and
perform an action set for the first system based at least on the modified solution implementation.

12. The apparatus of claim 11, wherein the mitigation engine is further configured to:
determine, based on the security ontology, a first resource associated with the historical security issue, and
cause, based on the first resource, deployment of a decoy resource within the first system.

13. The apparatus of claim 12,
wherein the communications hardware is further configured to receive attack interaction data associated with the decoy resource, and
wherein generating the modified solution implementation is further based on the attack interaction data.

14. The apparatus of claim 13, wherein the modeling engine is further configured to update the security ontology based on the attack interaction data.

15. The apparatus of claim 11, wherein the operational data comprises one or more of log data, network traffic data, performance data, and user behavior data.

16. The apparatus of claim 11, wherein the context data comprises configuration data and defense data of the first system.

17. The apparatus of claim 11, wherein modeling engine is configured to determine that the first system is undergoing the security issue that corresponds to the historical security issue associated with the second system by:
generating a feature vector set based on the operational data,
processing the feature vector set using a plurality of models to produce model output data, and
comparing the feature vector set to one or more historical issues stored by the security ontology to produce a similarity score set,
wherein the modeling engine determines that the first system is undergoing the security issue based at least on the model output data and the similarity score set.

18. The apparatus of claim 11, wherein the communications hardware is further configured to automatically cause deployment of a resource set to the first system.

19. The apparatus of claim 18, wherein the resource set comprises instructions to quarantine one or more components of the first system.

20. The apparatus of claim 18, wherein the resource set comprises one or more decoy resources.
